(19) United States
(12) Patent Application Publication
(10) Pub. No.: US 2020/0131657 A1
(43) Pub. Date: Apr. 30, 2020

(54) OXYGEN ELECTRODE COMPRISING DUAL PLATING CATALYST, WATER ELECTROLYSIS DEVICE AND REGENERATIVE FUEL CELL COMPRISING THE SAME, AND METHOD FOR PREPARING THE OXYGEN ELECTRODE

(71) Applicant: KOREA INSTITUTE OF SCIENCE AND TECHNOLOGY, Seoul (KR)

(72) Inventors: Hyun Seo PARK, Seoul (KR); Jong Hyun JANG, Seoul (KR); Hee-Young PARK, Seoul (KR); Jin Young KIM, Seoul (KR); So Young LEE, Seoul (KR); Sung Jong YOO, Seoul (KR); Dirk Henkensmeier, Seoul (KR); Hyoung-Juhn KIM, Seoul (KR); Ahyoun LIM, Seoul (KR); Junyoung KIM, Seoul (KR); Hye Jin LEE, Seoul (KR)

(73) Assignee: KOREA INSTITUTE OF SCIENCE AND TECHNOLOGY, Seoul (KR)

(21) Appl. No.: 16/590,857

(22) Filed: Oct. 2, 2019

(30) Foreign Application Priority Data
Oct. 26, 2018 (KR) 10-2018-0129038
Apr. 19, 2019 (KR) 10-2019-0046074

(51) Int. Cl. C25D 5/10; H01M 8/18; H01M 4/92; H01M 4/90; H01M 4/86; C25B 1/04; C25B 11/04; C25D 3/50; C25D 9/08

(52) U.S. Cl. CPC C25D 5/10; H01M 8/18; H01M 4/925; H01M 4/9016; H01M 4/8657; C25D 9/08; C25B 11/0405; C25B 11/0415; C25B 11/0478; C25D 3/50; C25B 1/04

(57) ABSTRACT

The present disclosure relates to an oxygen electrode comprising a dual plating catalyst, a water electrolysis device and a regenerative fuel cell comprising the same, and a method for preparing the oxygen electrode.

### DESCRIPTION OF GOVERNMENT-SPONSORED RESEARCH AND DEVELOPMENT

This research is sponsored by Ministry of Trade, Industry and Energy, New Renewable Energy Core Technology Development (Development of 350 atm polymer electrolyte water electrolysis cell stack technology to reduce hydrogen production cost, Project Serial No.: 1415154407) under the management of Korea Institute of Energy Technology Evaluation and Planning.

### CROSS-REFERENCE TO RELATED APPLICATION

This application claims the priority of Korean Patent Application No. 10-2018-0129038 filed on Oct. 26, 2018 and No. 10-2019-0046074 filed on Apr. 19, 2019, and all the benefits accruing therefrom under 35 U.S.C. § 119, the contents of which in its entirety are herein incorporated by reference.

### BACKGROUND OF THE INVENTION

### Field of the Invention

The present disclosure relates to an oxygen electrode comprising a dual plating catalyst, a water electrolysis device and a regenerative fuel cell comprising the same, and a method for preparing the oxygen electrode. More specifically, the present disclosure relates to an oxygen electrode including a dual plating catalyst in which a platinum (Pt) layer and an iridium oxide layer are electroplated on a substrate in order, a water electrolysis device and a regenerative fuel cell comprising the same, and a method for preparing the oxygen electrode.

### Description of the Related Art

New renewable energy such as solar power and wind power generation has been attracting attention as a potential new alternative energy source for fossil fuels as climatic changes have become a serious environmental issue. The electricity generated from the new renewable energy is intermittent and needs to be stored in a single form of fuel, and hydrogen is the most promising alternative fuel candidate. In the case of water electrolysis used as a hydrogen fuel-producing technology, hydrogen and oxygen can be produced by electrolyzing water. In the case of fuel cells, hydrogen and oxygen fuel can be used to produce electricity. Additionally, there have been many studies on fuel cells to an extent that the fuel cells are applied to automobiles, and thereby enabling commercialization of hydrogen cars.

Meanwhile, referring to Formulae 1 and 2 below, regenerative fuel cells, as a system capable of functioning as both the water electrolysis device and the fuel cell, are devices used for the storage and conversion of electrochemical energy. Referring to FIGS. 1, 2a and 2b, a unitized regenerative fuel cell (hereinafter, URFC) is an electrochemical energy conversion cell that performs two functions in a single device and has an effect of lowering the cost compared to a discrete regenerative fuel cell.

Oxygen electrode: H₂O→½O₂+2H⁺+2e⁻

Hydrogen electrode: 2H++2e⁻→H₂ [Formula 1] Water electrolysis mode:

Oxygen electrode: ½O₂+2H⁺+2e⁻→H₂O

Hydrogen electrode: H₂→2H⁺+2e⁻ [Formula 2] Fuel cell mode:

However, the URFC requires an excessive amount of noble metal catalysts in the production of an electrode, leading to a significantly high system cost. An oxygen generation reaction during water electrolysis and an oxygen reduction reaction during fuel cell operation are slow reactions and have used noble metal catalysts such as Ir (or RuO₂, iridium oxide) and Pt.

Although there have been many studies on non-noble metal catalysts to solve such problems, there is no substitute for catalysts having activity and stability as high as those of Ir (or RuO₂, iridium oxide) and Pt under an acidic condition. Accordingly, it is necessary to raise high activity with reduced contents of the noble metal catalysts.

### CITATION LIST

### Patent Literature

Patent Literature 1: Korean Publication Application No. 10-2010-0088176
Patent Literature 2: Korean Publication Application No. 10-2017-0058352

### Non-Patent Literature

Non-Patent Literature 1: T. Ioroi, N. Kitazawa, K. Yasuda, Y. Yamamoto, H. Takenaka. Journal of Applied Electrochemistry 31 (2001): 1179-1183.
Non-Patent Literature 2: Wenli Yao, Jun Yang, Jiulin Wang, Yanna Nuli. Electrochemistry Communications 9 (2007): 1029-1034.
Non-Patent Literature 3: Byung-Seok Lee, Hee-Young Park, Min Kyung Cho, JeaWoo Jung, Hyoung-Juhn Kim, Dirk Henkensmeier, Sung Jong Yoo, Jin Young Kim, Sehkyu Park, Kwan-Young Lee, Jong Hyun Jang. Electrochemistry Communications 64 (2016) 14-17.
Non-Patent Literature 4: 2016 Int. J. Hydro. energy, 41, 20650-20659
Non-Patent Literature 5: 2012 Int. J. Hydro. Energy, 37, 13522-13528
Non-Patent Literature 6: 2011 Electrochimica Acta, 56, 4287-4293
Non-Patent Literature 7: 2012 J. Power Sources., 198, 23-29

### SUMMARY OF THE INVENTION

The purpose of the present disclosure is to provide an oxygen electrode showing an excellent effect while reducing loading amounts of noble metals, particularly platinum and iridium oxide, specifically an oxygen electrode including a dual plating catalyst in which a platinum (Pt) layer and an iridium oxide layer are electroplated on a substrate in order, a water electrolysis device and a regenerative fuel cell comprising the same, and a method for preparing the oxygen electrode.

In an exemplary embodiment of the present disclosure, an oxygen electrode including a substrate; a Pt layer formed on the substrate by electroplating; and an iridium oxide layer formed on the Pt layer by electroplating is provided.

In an exemplary embodiment, a water electrolysis device including the oxygen electrode is provided.

In an exemplary embodiment, a regenerative fuel cell including the oxygen electrode is provided.

In an exemplary embodiment, a method for preparing the oxide electrode, including forming a Pt layer on a substrate by electroplating, and forming an iridium oxide layer on the Pt layer by electroplating is provided.

### BRIEF DESCRIPTION OF THE DRAWINGS

FIG. 1 is a conceptual diagram of a conventional unitized regenerative fuel cell (URFC) operation;

FIGS. 2A and 2B are conceptual diagrams simply showing water electrolysis and fuel cell operations of a general URFC;

FIG. 3A is a drawing illustrating a conventional spray method of manufacturing a catalyst, and FIG. 3B is a drawing illustrating an electroplating method according to an exemplary embodiment of the present disclosure;

FIGS. 4A and 4B are drawings illustrating a conventional oxygen electrode, and FIG. 4C is a drawing illustrating an oxygen electrode according to an exemplary embodiment of the present disclosure;

FIGS. 5A to 5C are scanning microscopy images of surfaces of an oxygen electrode (5A) in which an iridium oxide layer was electroplated on the substrate, an oxygen electrode (5B) in which a Pt layer was electroplated on the substrate, and an oxygen electrode (5C) in which the Pt layer and the iridium oxide layer were electroplated on the substrate in order;

FIGS. 6A and 6B are graphs showing performances of the fuel cell and the water electrolysis according to the electroplating time of the Pt layer of the oxygen electrode in Examples and Comparative Examples;

FIGS. 7A and 7B are graphs showing performance of water electrolysis of a dual plating electrode according to the loading amount of the Pt layer of the oxygen electrode (FIG. 7A) and that according to the total loading amount of noble metal catalysts in the oxygen electrode (FIG. 7B) in Examples and Comparative Examples;

FIG. 8 is a graph showing performance of water electrolysis of the cases in Examples and Comparative Examples, in which only the Pt layer is electroplated on the substrate of the oxygen electrode, in which only an iridium oxide layer is electroplated, and in which the Pt layer and the iridium oxide layer are electroplated on the substrate in order;

FIG. 9 is a graph showing fuel cell performance of the cases in which the Pt layer and the iridium oxide layer are electroplated on the substrate of the oxygen electrode in order and in which the iridium oxide layer is electroplated on the substrate followed by spraying the Pt layer thereon, when the iridium oxide-loading amounts are the same, in Examples and Comparative Examples; and

FIG. 10 is a graph showing circulation efficiency of the URFC when the catalyst-loading amounts are similar in Examples and Comparative Examples (reference 1-4).

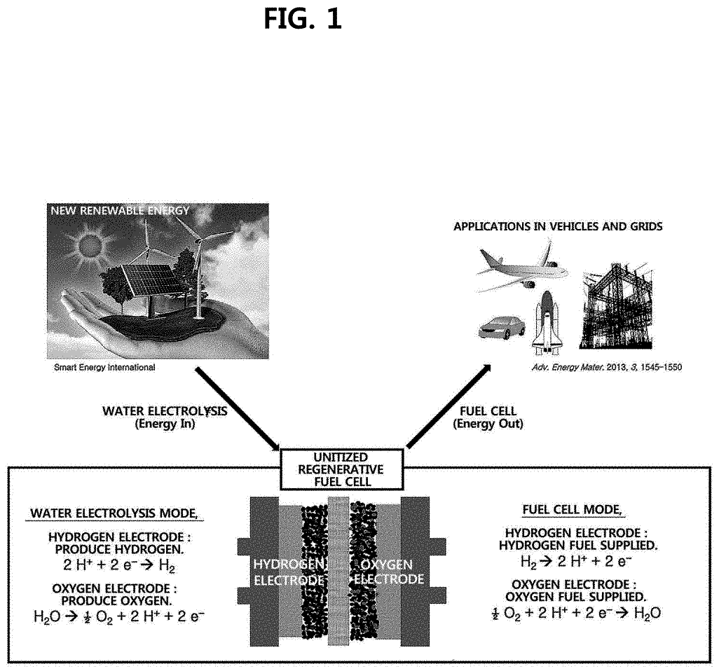

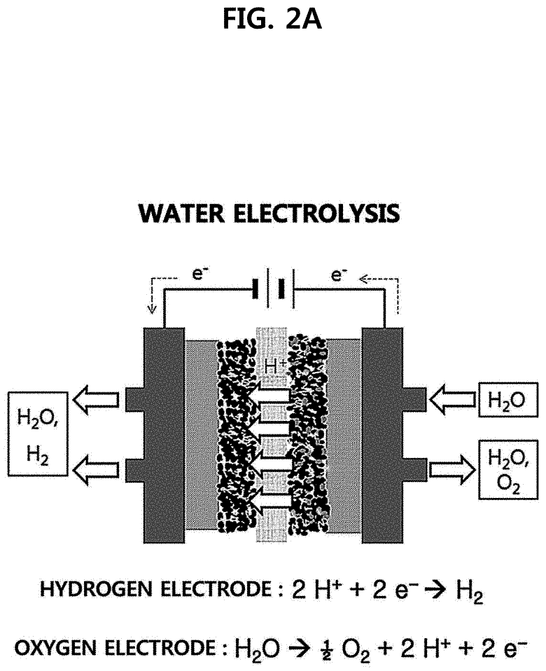

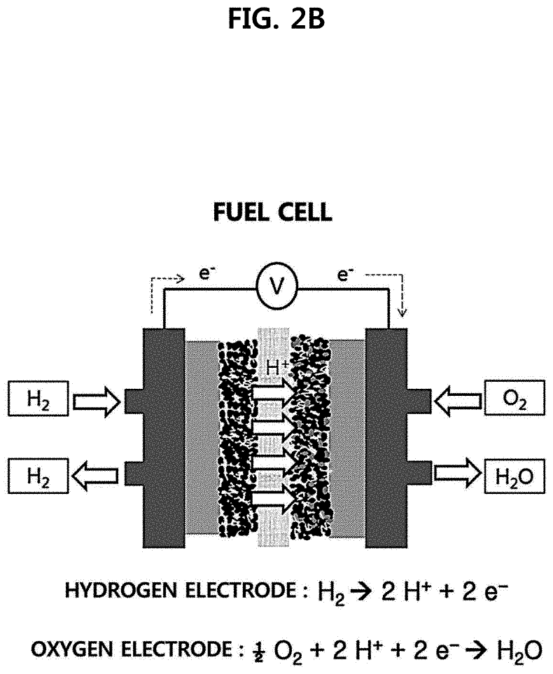

### DETAILED DESCRIPTION OF THE PREFERRED EMBODIMENTS

Hereinafter, exemplary embodiments of the present disclosure will be described in detail with reference to the accompanying drawings.

The present disclosure may, however, be embodied in many different forms and should not be construed as being limited to the embodiments set forth herein. Rather, these embodiments are provided so that the present disclosure will be thorough and complete and will fully convey the concept of the invention to those of ordinary skill in the art.

In the specification, unless otherwise specifically indicated, when a certain part “includes” a certain component, it is understood that other components may be further included but are not excluded.

Oxygen Electrode

In exemplary embodiments, an oxygen electrode comprising a substrate; a Pt layer formed on the substrate by electroplating; and an iridium oxide layer formed on the Pt layer by electroplating is provided.

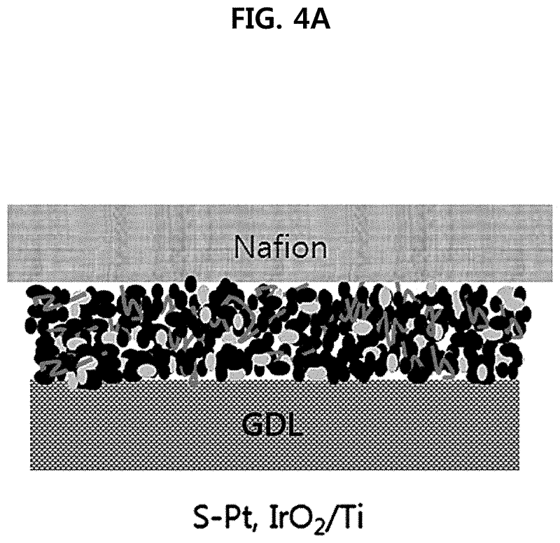

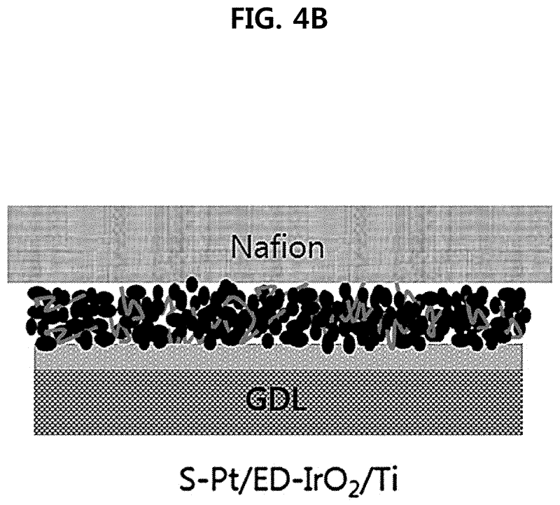

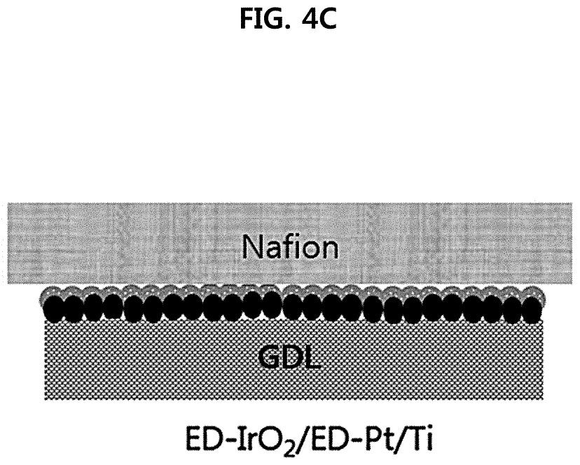

Referring to FIGS. 4A to 4C, conventional techniques are mainly involved with the spray method to form catalyst layers by developing a catalyst of iridium oxide loaded on Pt or a catalyst of Pt loaded on iridium oxide, an electrode in which Pt is sprayed on after iridium oxide is plated; for example, by spraying both oxygen-generating catalyst and oxygen-reducing catalyst (FIG. 4A), spraying the oxygen-reducing catalyst after plating the oxygen-generating catalyst (FIG. 4b). In this case, however, excessive amounts of catalysts (for example, 1 mg/cm² to 3 mg/cm²) are used, resulting in a large amount of noble metals being lost.

In contrast, the present inventors have developed techniques of fuel cells and water electrolysis having excellent performance due to a synergistic effect by forming catalyst layers in which small amounts of Pt and iridium oxide are loaded and chemically linked to each other, where the catalyst layers of the oxygen electrode are formed by electroplating an oxygen-generating catalyst on an electroplated oxygen-reducing catalyst using dual plating (FIG. 4C).

Specifically, when forming catalyst layers (a Pt layer and an iridium oxide layer) on the substrate, the oxygen electrode of the present disclosure, in contrast to the spray method, involves loading the catalyst layers on the substrate by electrochemical reactions (electroplating), not by physical bonding. Additionally, a nanometer-thick catalyst layer can be loaded on the substrate when electroplating is performed, and loss of catalyst-active area is reduced, thereby giving rise to high catalytic activity with a small loading amount. The loading amounts of catalysts are easily controlled according to plating conditions.

In a non-limiting example, the substrate is a gas diffusion layer and may have a porosity of 60%.

In exemplary embodiments, the oxygen electrode may be for a water electrolysis device or a regenerative fuel cell.

In exemplary embodiments, the Pt layer may refer to Pt particles adhered to or deposited on the substrate. Specifically, the Pt layer covers the substrate, while it is preferable that the Pt layer covers the substrate so that substrate materials are not exposed. That is, a preferable structure is an exposure-free structure having no exposure of the substrate material while the Pt layer is covering a surface of the substrate.

In exemplary embodiments, the iridium oxide layer may refer to iridium oxide particles surrounding the Pt layer or Pt particles. Specifically, when the iridium oxide layer is electroplated on the Pt layer, the iridium oxide particles surround the Pt layer or Pt particles and may be a type of catalyst involving electrochemical reactions and not physical bonding. Accordingly, a surface area of the iridium oxide increases, thereby water electrolysis increases.

The iridium oxide may have a formula of IrOₓ, where x may be 1.5 to 2.5.

In a non-limiting example, the surface area of the iridium oxide may be 25 cm²/cm²_{geo} to 200 cm²/cm²_{geo}.

In a non-limiting example, the Pt layer has a thickness of 0.01 μm to 1.2 μm, preferably 10 nm to 500 nm, and the Pt particles have a size of 3 nm to 20 nm, preferably 2 nm to 10 nm.

In a non-limiting example, the iridium oxide layer has a thickness of 0.01 μm to 1 μm, preferably 10 nm to 100 nm, and the iridium oxide particle has a size of 1 nm to 10 nm, preferably 1.5 nm to 2 nm.

In exemplary embodiments, the Pt layer may have a total weight of 0.05 mg/cm² to 0.5 mg/cm². If the weight of Pt is less than 0.05 mg/cm², it may result in poor performance in the fuel cell mode. IF the weight of Pt is greater than 0.5 mg/cm², it may result in reduced catalytic activity per mass in the water electrolysis mode.

In exemplary embodiments, the Pt layer and iridium oxide layer may have a total weight of 0.1 mg/cm² to 1.0 mg/cm². If the total weight of Pt layer and iridium oxide layer is less than 0.1 mg/cm², it may result in poor performance in the fuel cell mode. IF the total weight of Pt layer and iridium oxide layer is greater than 1.0 mg/cm², it may result in reduced catalytic activity per mass in the water electrolysis mode.

In exemplary embodiments, the substrate may be a titanium paper composed of titanium fibers. Existing electrodes have an issue of carbon corrosion as they use carbon materials as the substrate; however, in the present disclosure, the electrode stability may be improved by using titanium.

In exemplary embodiments, the oxygen electrode may be used for a regenerative fuel cell operated at a current density of 0.1 A/cm² or higher.

In exemplary embodiments of the present disclosure, a water electrolysis device including the oxygen electrode is provided.

In exemplary embodiments of the present disclosure, a regenerative fuel cell including the oxygen electrode is provided

In exemplary embodiments, the regenerative fuel cell may be a URFC.

Method for Preparing Oxygen Electrode

In exemplary embodiments of the present disclosure, a method for preparing an oxygen electrode comprising forming a Pt layer on a substrate by electroplating; and forming an iridium oxide layer on the Pt layer by electroplating is provided as a method for preparing the oxygen electrode previously described.

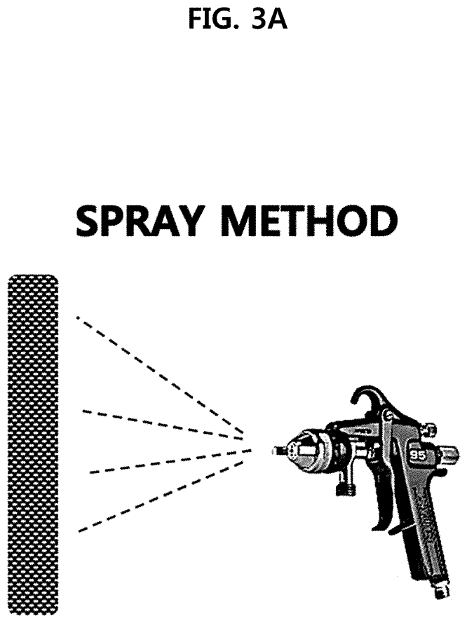

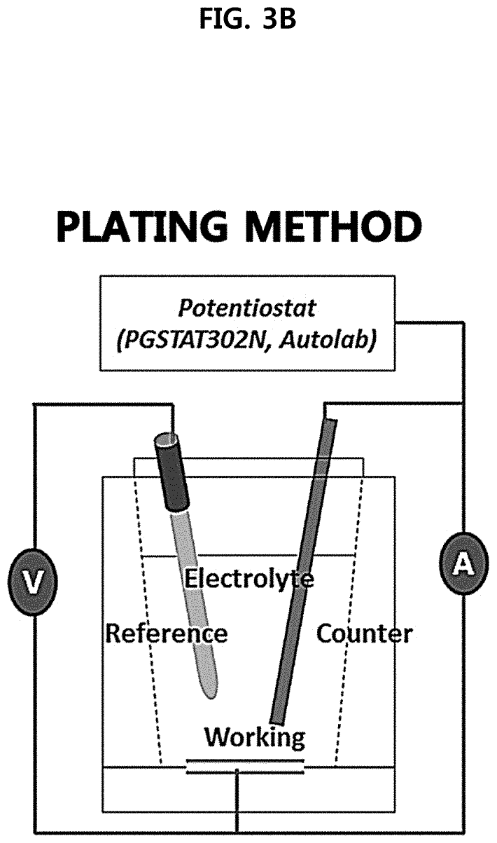

Referring to FIG. 3A, a conventional method for preparing an electrode involves producing catalyst-containing slurry including a catalyst, an ionomer solution, isopropyl alcohol, water, etc. and spraying a desired amount of the slurry on a substrate using a sonication spray gun for 1 hour.

In contrast to the spray method, referring to FIG. 3B, the oxygen electrode of the present disclosure involves formation of a Pt layer and an iridium oxide layer by electroplating, leading to loading on the substrate by electrochemical reactions and not by physical bonding with the substrate, and enables loading of nanometer-thick catalyst layers on the substrate. Further, due to reduced loss of catalyst-active area, high catalytic activity can be obtained with small loading amounts. It is easy to control loading amounts of catalysts according to deposition conditions.

In exemplary embodiments, at least one of the plating current and the plating time can be controlled during the formation of the Pt layer on the substrate by electroplating.

In exemplary embodiments, the plating current may be −100 mA cm⁻² to −5 mA cm⁻², for example, −50 mA cm⁻² to −5 mA cm⁻², or preferably −10 mA cm⁻², during the formation of a Pt layer on the substrate by electroplating.

In exemplary embodiments, the plating time may be 30 seconds to 10 minutes, preferably 5 minutes to 8 minutes during electroplating a Pt layer on the substrate. A plating time of less than 30 seconds may result in insufficient plating whereas a plating time exceeding 10 minutes may incur unnecessary expenses as the performance is not proportional to the noble metal amounts and thus does not improve.

The present disclosure will be described in more detail with reference to the following examples. However, the following examples are for illustrative purposes and the scope of the present disclosure is not limited by the examples.

### EXAMPLES

### Example 1. Preparation of Oxygen Electrode: Plating Pt Layer on Ti Paper (250 μm, Bekaert)

Chloroplatinic acid hydrate (99.995%, Sigma Aldrich) was added to a 0.5 M H₂SO₄ solution and sonicated for 30 minutes. A titanium paper was acidized in an oxalic acid solution of 60° C. for 30 minutes before plating. The plating was then performed at a constant current of 10 mA/cm². The plating time was adjusted to 30 seconds, 1 minute, 2 minutes, 5 minutes, 8 minutes and 10 minutes.

### Example 2. Preparation of Oxygen Electrode: Plating of Iridium Oxide

Iridium chloride hydrate (IrCl₄.H₂O), oxalic acid ((COOH)₂.2H₂O), hydrogen peroxide (35% H₂O₂) and anhydrous potassium carbonate were added to deionized water (DI water) and magnetically stirred for 3 days. The plating was then performed on the electrode from Example 1 on which the Pt layer is plated for 10 minutes under 0.7 V (vs. SCE).

### Example 3. Preparation of Hydrogen Electrode: Pt/C Spray

Slurry was prepared as follows in order to load catalysts on the electrode: 46.2 wt % Pt/C, DI water, 5 wt % nafion solution, and isopropanol were added and sonicated for 1 hour. 0.4 mg/cm² of the slurry was sprayed on OBC (SCL carbon Ltd.).

### Example 4. Preparation of a URFC

A hydrogen electrode, Nafion 212, and an oxygen electrode prepared to prepare a membrane electrode assembly (MEA) were stacked in order and hot pressed at a pressure of 2.7 Mpa at 120° C. for 1 minute. A cell was assembled with 80 Lbin.

### Example 5. Evaluation of URFC Performance

In the water electrolysis mode, DI water was supplied to the oxygen electrode at a rate of 15 mL/min under a cell temperature of 80° C. An entrance of the hydrogen electrode was blocked so as to prevent gas from entering from the outside. While raising from 1.25 V to 2.0 V at 0.5 V interval, the performance was measured for 1 minute at each voltage. Current densities measured at each voltage were recorded every 10 seconds and averaged to obtain a current density at each voltage.

In the fuel cell mode, the cell temperature was maintained at 80° C. as in the water electrolysis mode, and a fuel being supplied was set at a temperature of 70° C. Oxygen was supplied to the oxygen electrode at a rate of 400 ccm, and hydrogen was supplied to the hydrogen electrode at a rate of 400 ccm. The performance was measured from OCV condition to 0.2 V.

### Comparative Example

When preparing an oxygen electrode, a URFC was prepared in the same manner as in the Example except that an iridium oxide layer or a platinum (Pt) layer was electroplated alone (ED-iridium oxide/Ti, ED-Pt/Ti).

When preparing a hydrogen electrode, a URFC was prepared in the same manner as in the Example except that an iridium oxide layer was electroplated on the substrate of the oxygen electrode followed by spraying a Pt layer thereon (spray-Pt/ED-iridium oxide/Ti).

### Test Example

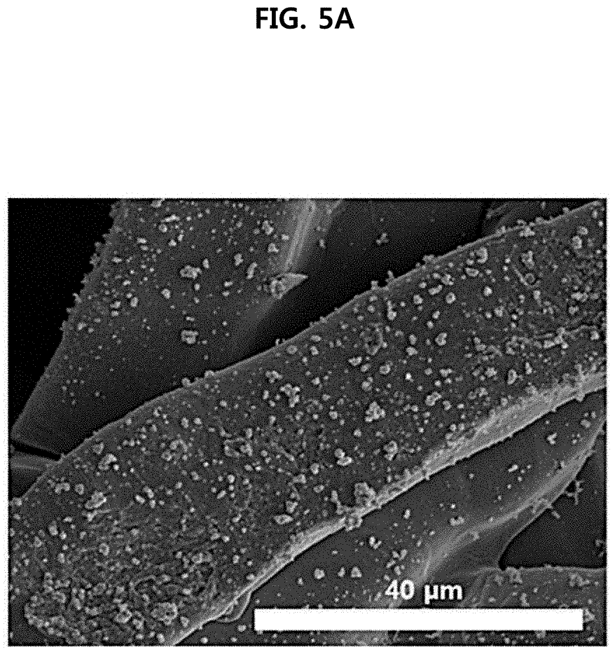

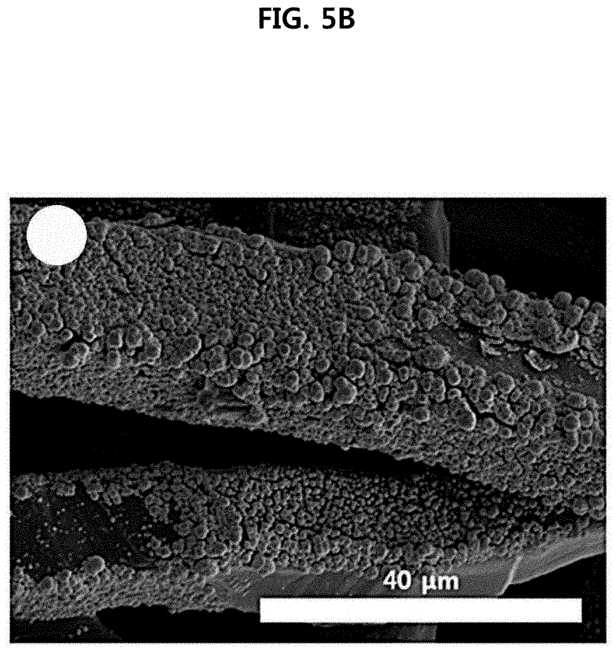

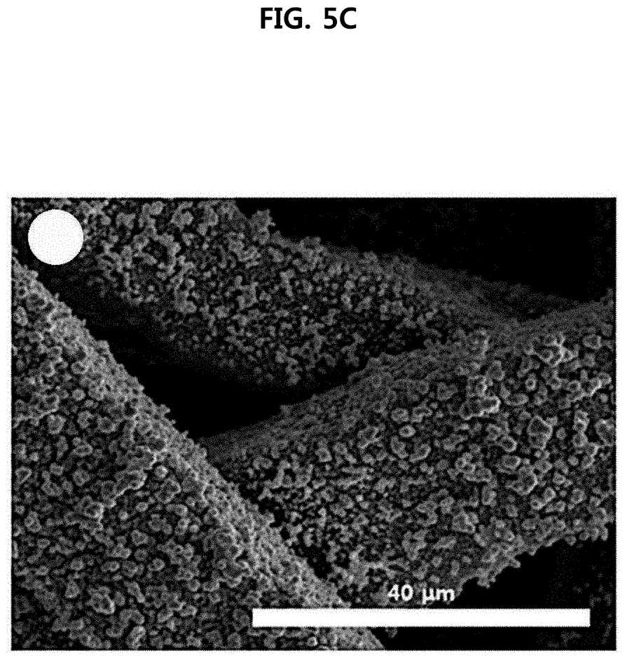

FIGS. 5A to 5C are scanning microscopy images of surfaces of an oxygen electrode (5A) in which the iridium oxide layer was electroplated on the substrate, an oxygen electrode (5B) in which the Pt layer was electroplated on the substrate, and an oxygen electrode (5C) in which the Pt layer and the iridium oxide layer were electroplated on the substrate in order. Based thereon, the oxygen electrode (5C) in which the Pt layer and the iridium oxide layer were electroplated in order has a larger surface area and rougher surface compared to the other oxygen electrodes.

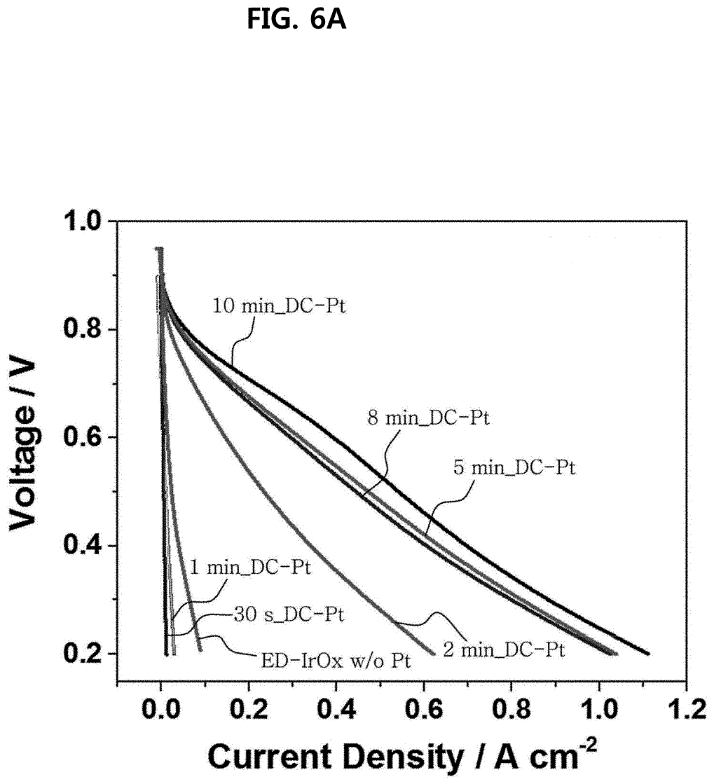

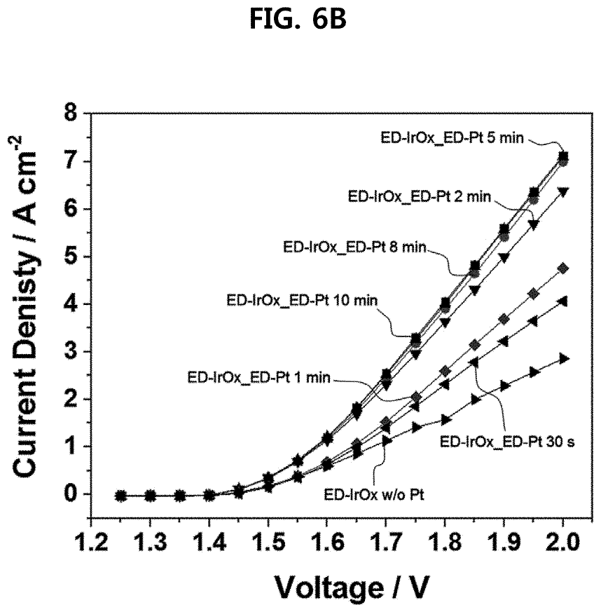

FIGS. 6A and 6B and Table 1 below are graphs showing performances of the fuel cell and the water electrolysis according to the electroplating time of the Pt layer of the oxygen electrode, when the iridium oxide-depositing times are the same in Examples and Comparative Examples. Based thereon, it can be confirmed that the fuel cell performance improves as the Pt-plating time increases, but does not significantly increase at a certain amount or more.

Particularly referring to FIG. 6B, compared to the case of plating an iridium oxide layer on a substrate having no electroplated Pt (ED-IrOx w/o Pt), water electrolysis performance drastically increases as the iridium oxide layer is electroplated on the Pt-plated electrode. It can also be confirmed that no further increase is observed in the water electrolysis performance after a certain Pt-plating time.

TABLE 1

| | | | | Current | Current |
|---|---|---|---|---|---|
| | | | | Density at | Density at |
| | Pt_{avg.}/mg cm⁻² | Ir_{avg.}/mg cm⁻² | Total/mg cm⁻² | 0.6 V/A cm⁻² | 1.9 V/A cm⁻² |
| ED-IrOx w/o | 0 | 0.150 | 0.150 | 0.014 | 2.29 |
| Pt | | | | | |
| ED-IrOx on | 0.079 | 0.063 | 0.142 | 0.004 | 3.22 |
| DC-Pt 30 s | | | | | |
| ED-IrOx | 0.136 | 0.075 | 0.211 | 0.005 | 3.69 |
| onDC-Pt | | | | | |
| 1 min | | | | | |
| ED-IrOx | 0.168 | 0.170 | 0.338 | 0.146 | 5.00 |
| onDC-Pt | | | | | |
| 2 min | | | | | |
| ED-IrOx | 0.277 | 0.157 | 0.434 | 0.316 | 5.57 |
| onDC-Pt | | | | | |
| 5 min | | | | | |
| ED-IrOx | 0.417 | 0.198 | 0.615 | 0.245 | 5.41 |
| onDC-Pt | | | | | |
| 8 min | | | | | |
| ED-IrOx | 0.661 | 0.255 | 0.916 | 0.392 | 5.60 |
| onDC-Pt | | | | | |
| 10 min | | | | | |

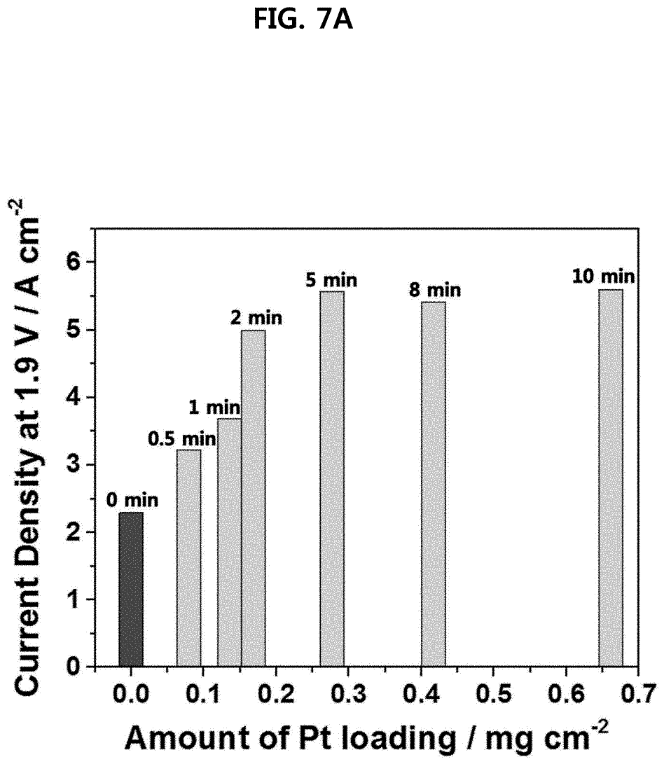

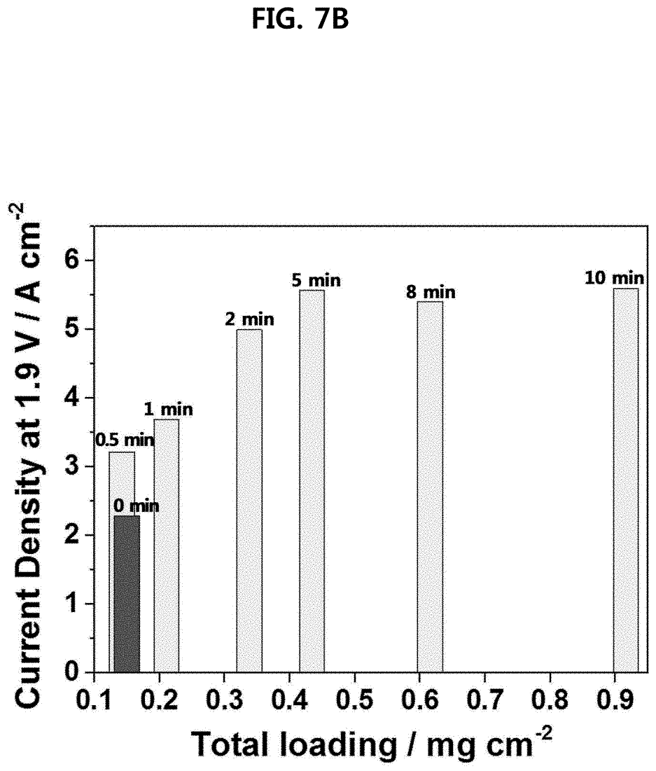

FIGS. 7A and 7B are graphs showing performance of water electrolysis of a dual plating electrode according to the loading amount of the Pt layer of the oxygen electrode (FIG. 7A) and that according to the total loading amount of noble metal catalysts in the oxygen electrode (FIG. 7B) in Examples and Comparative Examples. Based thereon, no significant increase is further observed in the water electrolysis performance at a certain Pt-loading amount or more, and sufficient water electrolysis performance is observed with a small amount of Pt of about 0.3 mg/cm². Specifically, when compared at 5 minutes, 8 minutes and 10 minutes, it is observed that there is no further effect that is proportional to the increasing loading amount of Pt and there is almost no increase rate.

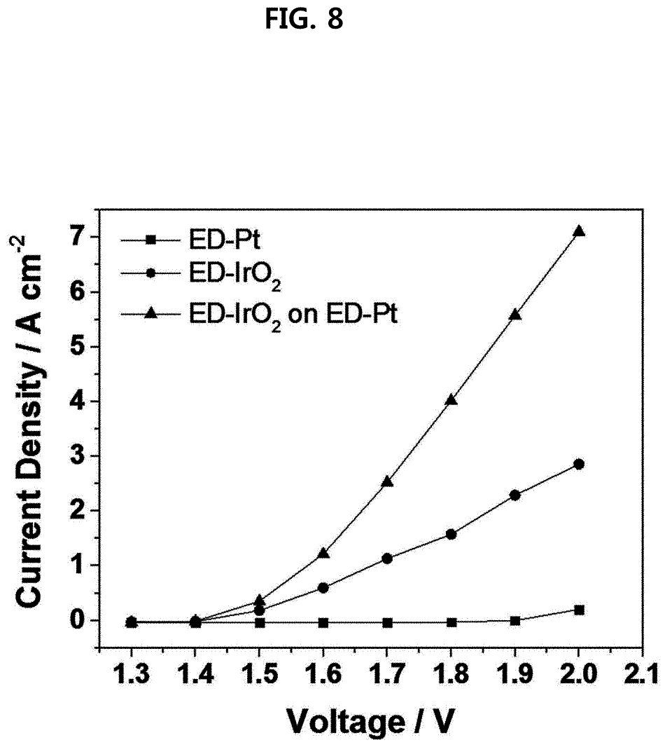

FIG. 8 is a graph showing water electrolysis performance of the cases in Examples and Comparative Examples, in which only the Pt layer is electroplated on the substrate of the oxygen electrode, in which only an iridium oxide layer is electroplated, and in which the Pt layer and the iridium oxide layer are electroplated on the substrate in order. Each Pt layer was electroplated for 5 minutes.

Based thereon, it was confirmed that although the water electrolysis performance is hardly exhibited when the Pt layer alone is electroplated on the substrate of the oxygen electrode, the water electrolysis performance rapidly increases when iridium oxide is plated on the Pt-plated electrode compared to the iridium oxide-plated electrode without plated Pt. It can also be seen that the current density increased at least 2.4 times from about 2.9 A/cm² to 7.1 A/cm² at 2.0 V.

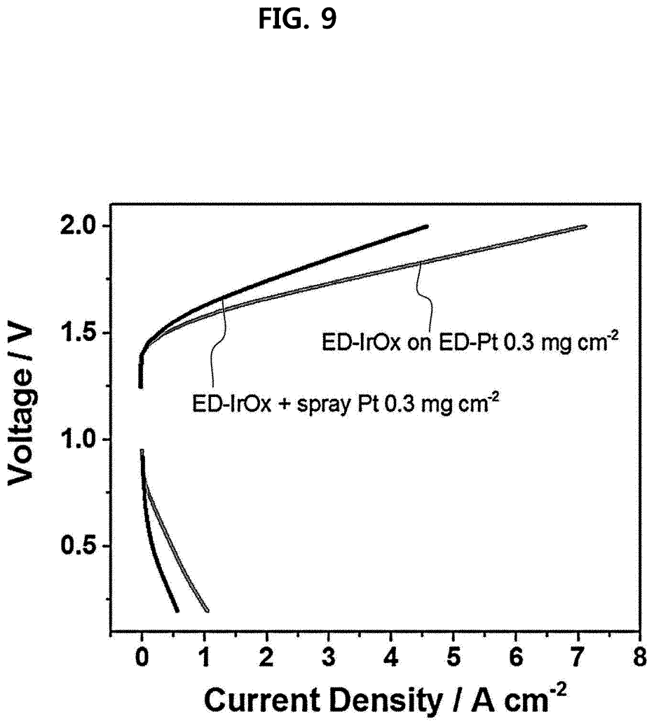

FIG. 9 is a graph showing fuel cell performance of the cases in which the Pt layer and the iridium oxide layer are electroplated on the substrate of the oxygen electrode in order and in which the iridium oxide layer is electroplated on the substrate followed by spraying the Pt layer thereon, when the iridium oxide-loading amounts are the same in Examples and Comparative Examples.

Based thereon, it can be seen that although the weights of deposited iridium oxide are similar, that is, about 0.15 mg/cm² to 0.2 mg/cm², the water electrolysis performance is twice higher. Based on FIG. 8, it is understood that such water electrolytic performance is not due to the plated Pt. Additionally, it can be confirmed that the fuel cell performance was also increased by two times compared to that of the electrode in which a similar amount of the Pt catalyst was sprayed.

Further, the current of water electrolysis per catalyst mass, which corresponds to 50% of the URFC circulation efficiency, is 5.6816 A/mg (1.7 V), while that of the fuel cell is 0.0294 A/mg (0.85 V). A product of the electrolytic current and the fuel cell current at URFC circulation efficiency of 50% in consideration of this is 0.171 (A/mg)².

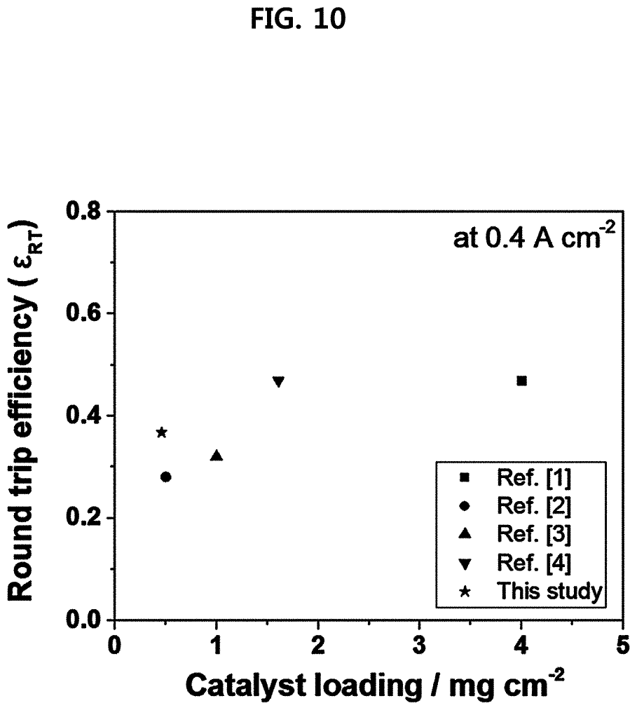

FIG. 10 is a graph showing circulation efficiency of the URFC when the catalyst-loading amounts are similar in Examples and Comparative Examples (reference 1-4). In particular, when compared to Ti GDL-used URFC researches such as [Reference 1] 2016 Int. J. Hydro. energy, 41, 20650-20659, [Reference 2] 2012 Int. J. Hydro. Energy, 37, 13522-13528, [Reference 3] 2011 Electrochimica Acta, 56, 4287-4293, [Reference 4] 2012 J. Power Sources., 198, 23-29, it was confirmed that higher circulation efficacy is exhibited with similar catalyst-loading amounts and similar circulation efficiency is observed with less than a half of the loading amounts of noble metal catalysts.

The oxygen electrode according to the present disclosure is electroplated with a Pt layer and an iridium oxide layer on a substrate in order, and involves loading by electrochemical reactions rather than physical bonding. Accordingly, when operating a water electrolysis device or a regenerative fuel cell, an excellent effect can be exhibited while reducing loading amounts of noble metals, particularly Pt.

Further, the method for preparing the oxygen electrode according to the present disclosure enables loading of nanometer-thick catalyst layers when electroplating the Pt or iridium oxide layer. Compared to the spray method, active area of the catalysts being lost are reduced, thereby facilitating the preparation of an oxygen electrode exhibiting high catalytic activity with small loading amounts.

While the present invention has been described with respect to the specific embodiments, it will be apparent to those skilled in the art that various changes and modifications may be made without departing from the spirit and scope of the invention as defined in the following claims.

1. An oxygen electrode, comprising:
a substrate;
a platinum (Pt) layer formed on the substrate by electroplating; and
an iridium oxide layer formed on the Pt layer by electroplating.

2. The oxygen electrode of claim 1, wherein the oxygen electrode is for a water electrolysis device.

3. The oxygen electrode of claim 1, wherein the oxygen electrode is for regenerative fuel cells.

4. The oxygen electrode of claim 1, wherein the Pt layer comprises Pt particles adhered to the substrate.

5. The oxygen electrode of claim 1, wherein the iridium oxide layer comprises iridium oxide particles surrounding the Pt layer or Pt particles.

6. The oxygen electrode of claim 1, wherein the Pt layer has a weight of 0.05 mg/cm² to 0.7 mg/cm².

7. The oxygen electrode of claim 1, wherein the Pt layer and iridium oxide layer have a total weight of 0.1 mg/cm² to 1.0 mg/cm².

8. The oxygen electrode of claim 1, wherein the substrate is a titanium paper composed of titanium fibers.

9. The oxygen electrode of claim 1, wherein the oxygen electrode is used for a regenerative fuel cell operated at a current density of 0.1 A/cm².

10. A water electrolysis device comprising the oxygen electrode according to claim 1.

11. A regenerative fuel cell comprising the oxygen electrode according to claim 1.

12. The regenerative fuel cell of claim 11, wherein the regenerative fuel cell is a unitized regenerative fuel cell (URFC).

13. A method for preparing the oxygen electrode according to claim 1, comprising:
forming a platinum (Pt) layer on a substrate by electroplating; and
forming an iridium oxide layer on the Pt layer by electroplating.

14. The method for preparing the oxygen electrode of claim 13, wherein forming a Pt layer on the substrate by electroplating involves controlling at least one of a plating current and a plating time.

15. The method for preparing the oxygen electrode of claim 14, wherein the plating current is −100 mA cm′ to −5 A cm⁻².

16. The method for preparing the oxygen electrode of claim 14, wherein the plating time is 30 seconds to 10 minutes.
